(19) United States
(12) Patent Application Publication
(10) Pub. No.: US 2026/0081408 A1
(43) Pub. Date: Mar. 19, 2026

(54) PROTECTIVE COVER ASSEMBLY STRUCTURE AND ELECTRICAL JUNCTION BOX

(71) Applicant: Yazaki Corporation, Tokyo (JP)

(72) Inventors: Kazuki KOBAYASHI, Shizuoka (JP); Naoki Sakaguchi, Shizuoka (JP); Shinya Oishi, Shizuoka (JP)

(73) Assignee: Yazaki Corporation, Tokyo (JP)

(21) Appl. No.: 19/328,679

(22) Filed: Sep. 15, 2025

(30) Foreign Application Priority Data
Sep. 17, 2024 (JP) 2024-160050

(51) Int. Cl. H02G 3/08

(52) U.S. Cl. CPC H02G 3/081

(57) ABSTRACT

The assembly structure for the protective cover includes the protective cover that, in an open position with respect to an assembly target member, exposes an opening of a main body portion of the assembly target member, and in a closed position with respect to the assembly target member, covers the opening with a main body of the protective cover; a pivot shaft provided on one of the assembly target member and the protective cover; and a bearing provided on the other of the assembly target member and the protective cover, the bearing having a clamping portion that clamps the pivot shaft.

### CROSS-REFERENCE TO RELATED APPLICATIONS

The present application claims priority to and incorporates by reference the entire contents of Japanese Patent Application No. 2024-160050 filed in Japan on September 17, 2024.

### BACKGROUND OF THE INVENTION

### 1. Field of the Invention

The present invention relates to a protective cover assembly structure and an electrical junction box.

### 2. Description of the Related Art

Conventionally, electrical junction boxes are sometimes provided with a protective cover that covers an electrical connection terminal exposed through an opening. Such a protective cover is configured, for example, so that the protective cover can be opened around an axis of a pivot shaft to allow operations such as connecting a conductive component to the electrical connection terminal. For example, Japanese Patent Application Laid-open No. 2014-27724 discloses an electrical junction box that includes a block and a frame that accommodates the block. In the electrical junction box of Japanese Patent Application Laid-open No. 2014-27724, the block includes a terminal support portion that supports an emergency terminal portion of a bus bar in a projecting state and a first cover support portion that is provided adjacent to the terminal support portion, and the frame includes a through-hole through which the emergency terminal portion is inserted during accommodation of the block and a second cover support portion that is provided adjacent to the through-hole. In an accommodated state in which the block is housed in the frame, a terminal cover is rotatably supported by having its shaft portion clamped between the first cover support portion and the second cover support portion.

However, in the electrical junction box as disclosed in Japanese Patent Application Laid-open No. 2014-27724, there remains room for further improvement, for example, in terms of the ease of assembly of the protective cover.

### SUMMARY OF THE INVENTION

In view of the foregoing circumstances, the present invention is intended to provide a protective cover assembly structure and an electrical junction box that are configured to improve the ease of assembly.

A protective cover assembly structure according to one aspect of the present invention includes a protective cover configured to, in an open position with respect to an assembly target member, expose an opening of a main body portion of the assembly target member, and in a closed position with respect to the assembly target member, cover the opening with a main body of the protective cover; a pivot shaft provided on one of the assembly target member and the protective cover; and a bearing provided on the other of the assembly target member and the protective cover, the bearing having a clamping portion that clamps the pivot shaft, wherein the bearing is configured to allow the protective cover to pivot about an axis of the pivot shaft between the open position and the closed position, the protective cover is configured to be assembled to the assembly target member by inserting the pivot shaft between the clamping portions at an assembly position that is further on an opening side beyond the open position, and the pivot shaft includes a recessed portion formed in a concave shape on an outer circumferential surface of the pivot shaft at a location facing the clamping portion in a state where the protective cover is in the assembly position.

An electrical junction box according to another aspect of the present invention includes a housing member that houses an electrical connection member having an electrical connection terminal configured to be physically and electrically connected to a conductive component of a counterpart device, the electrical connection terminal being exposed through an opening of the housing member; a protective cover that, in an open position with respect to the housing member, exposes the opening of the housing member and the electrical connection terminal, and in a closed position with respect to the housing member, covers the opening and the electrical connection terminal with a main body of the protective cover; a pivot shaft provided on one of the housing member and the protective cover; and a bearing provided on the other of the housing member and the protective cover, the bearing having a clamping portion that clamps the pivot shaft, wherein the bearing is configured to allow the protective cover to pivot about an axis of the pivot shaft between the open position and the closed position, the protective cover is configured to be assembled to the housing member by inserting the pivot shaft between the clamping portions at an assembly position that is further on an opening side beyond the open position, and the pivot shaft includes a recessed portion formed in a concave shape on an outer circumferential surface of the pivot shaft at a location facing the clamping portion in a state where the protective cover is in the assembly position.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view illustrating a protective cover assembly structure and an electrical junction box according to an embodiment;

FIG. 2 is a perspective view illustrating a protective cover assembly structure and an electrical junction box according to an embodiment, with the protective cover illustrated in an assembly position;

FIG. 3 is a perspective view illustrating a protective cover according to an embodiment;

FIG. 4 is a plan view illustrating a cover member according to an embodiment;

FIG. 5 is a cross-sectional view taken along line A-A in FIG. 2;

FIG. 6 is a plan view illustrating a protective cover assembly structure according to an embodiment, with the protective cover illustrated in an assembly position;

FIG. 7 is a perspective view of a protective cover assembly structure according to an embodiment from a different angle, with the protective cover illustrated in an assembly position;

FIG. 8 is a perspective view illustrating a protective cover assembly structure and an electrical junction box according to an embodiment, with the protective cover illustrated in an open position;

FIG. 9 is a perspective view illustrating a protective cover assembly structure and an electrical junction box according to an embodiment from a different angle, with the protective cover illustrated in an open position;

FIG. 10 is a cross-sectional view taken along line B-B in FIG. 8; and

FIG. 11 is a perspective view illustrating a protective cover assembly structure and an electrical junction box according to an embodiment, with the protective cover illustrated in a closed position.

### DETAILED DESCRIPTION OF THE PREFERRED EMBODIMENTS

Embodiments of a protective cover assembly structure and an electrical junction box according to the present invention are now described in detail with reference to the drawings. Moreover, the present invention is not limited to embodiments described herein. Furthermore, the components described in the following embodiments may include those that would be readily conceived by those skilled in the art or those that are substantially equivalent.

### Embodiments

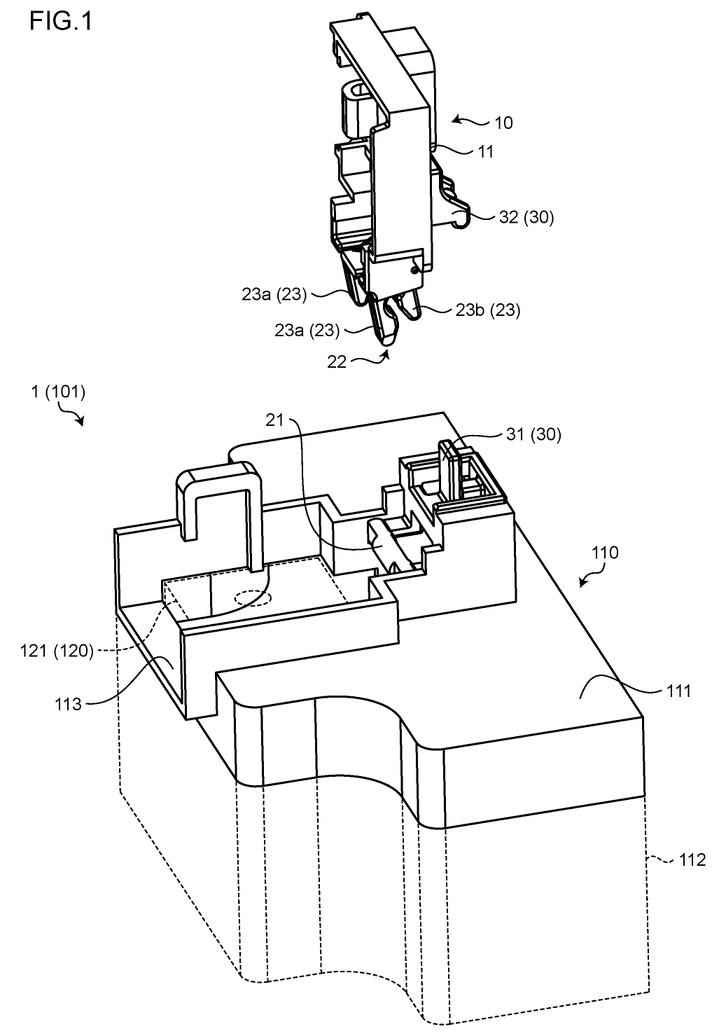

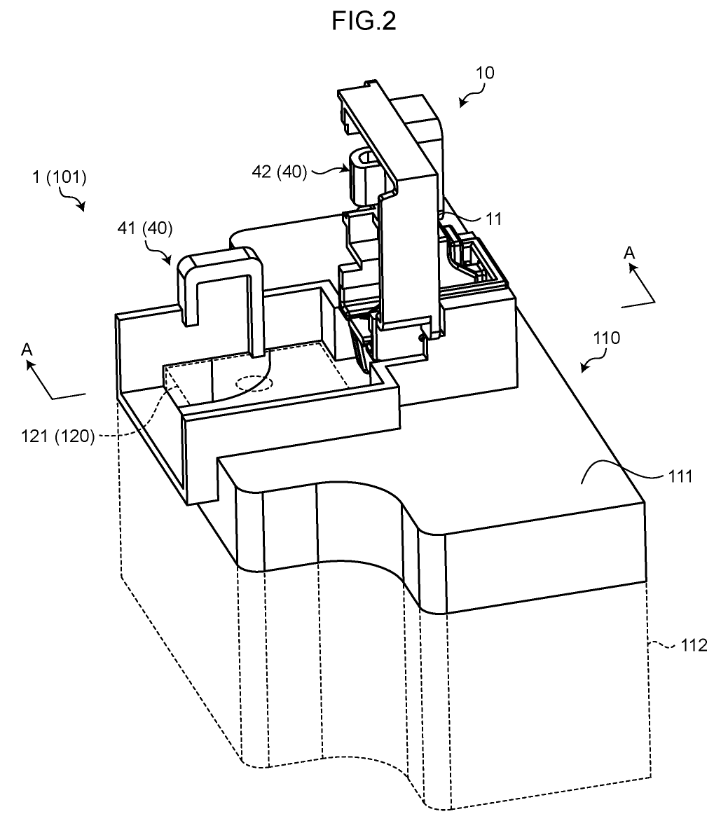

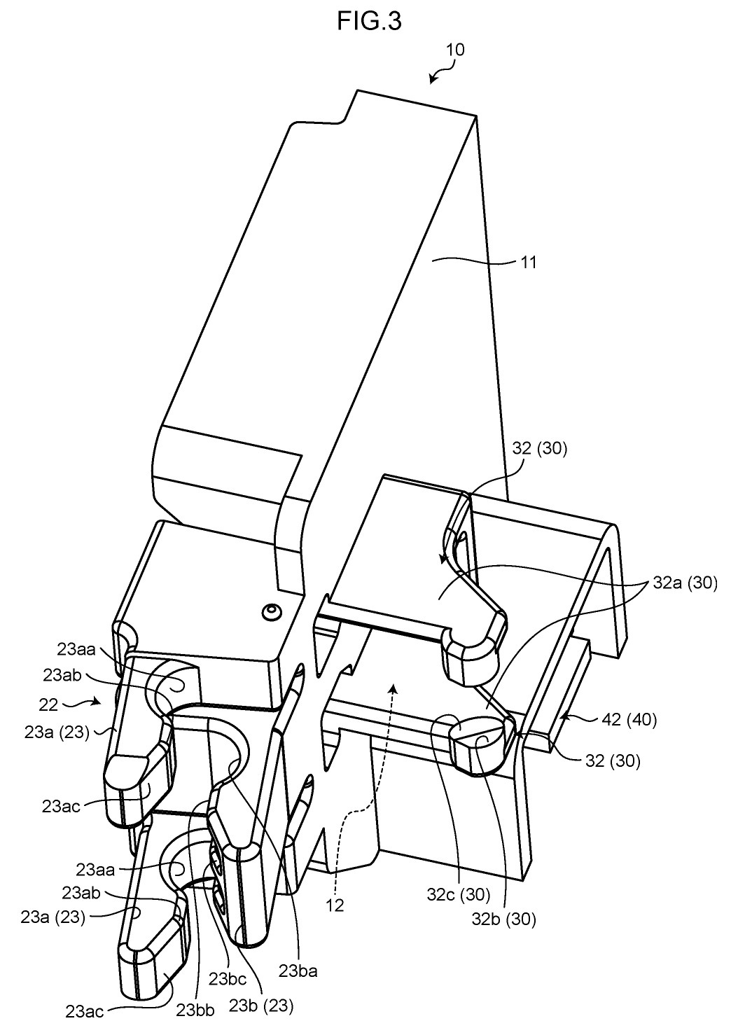

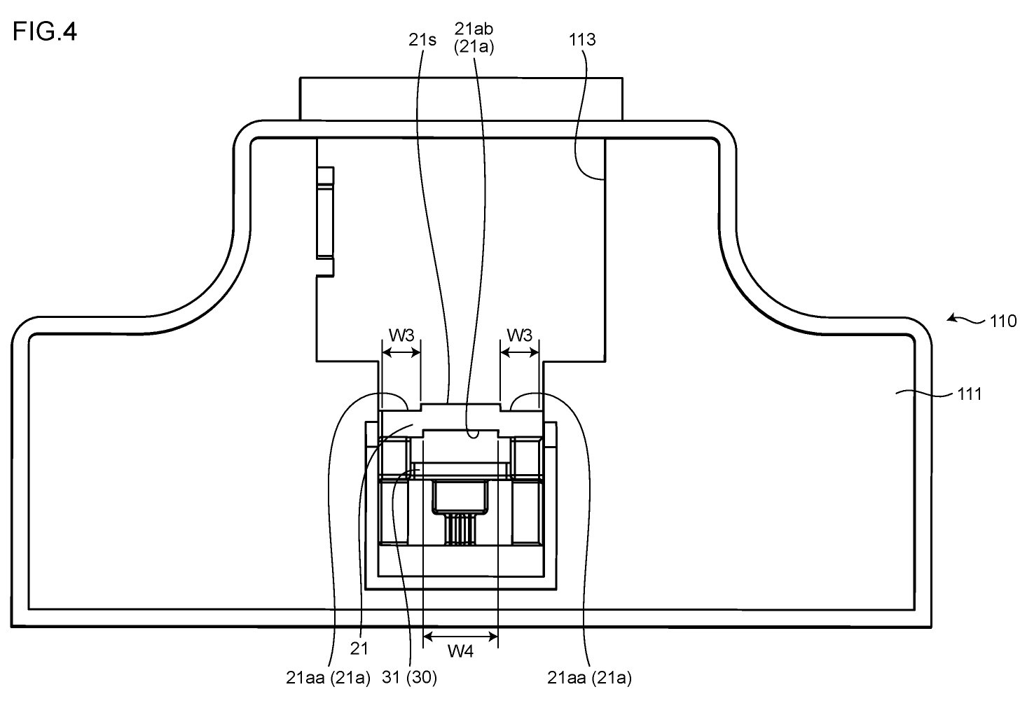

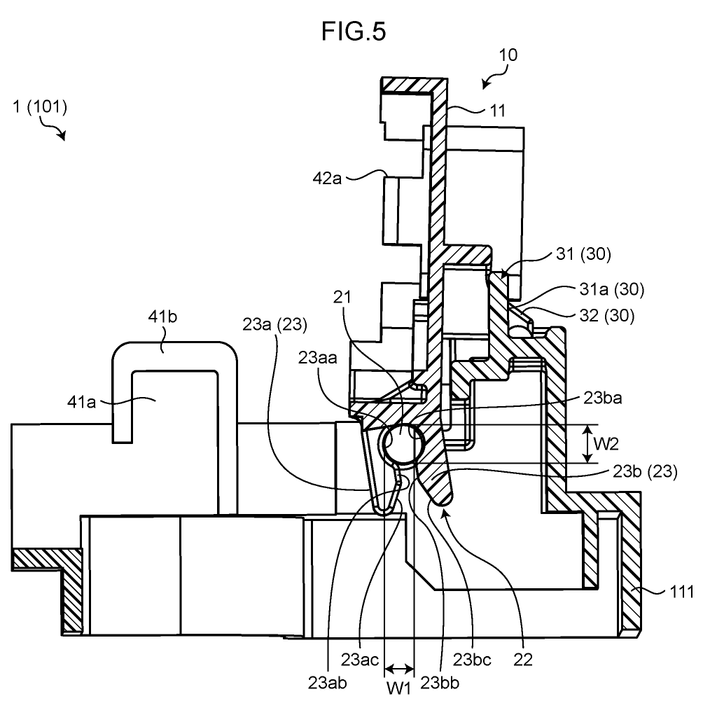

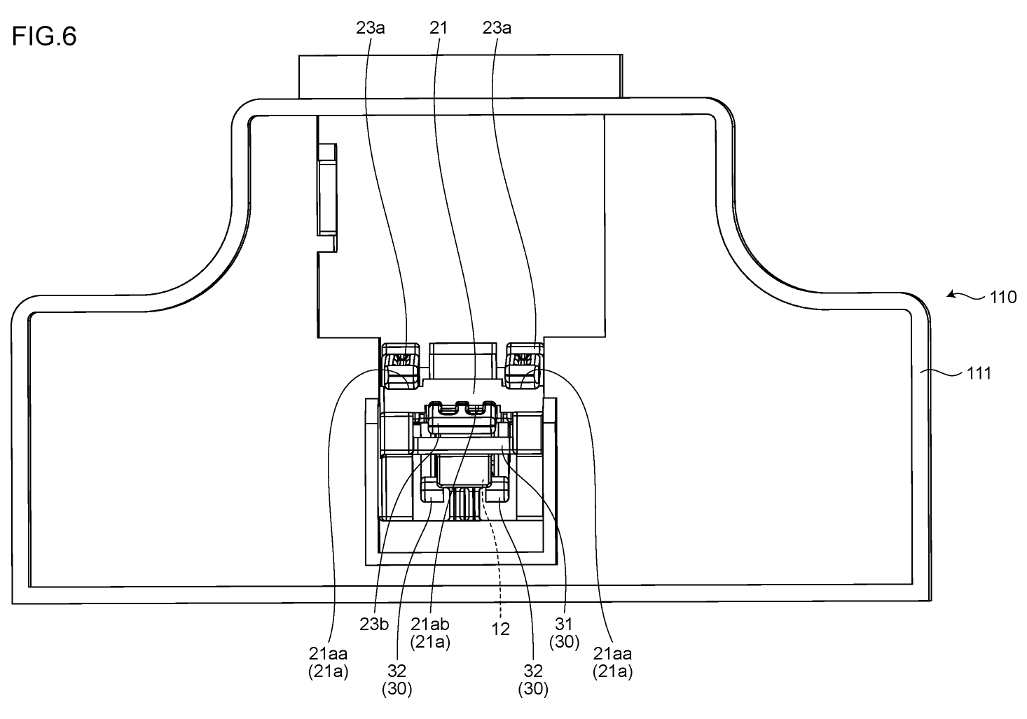

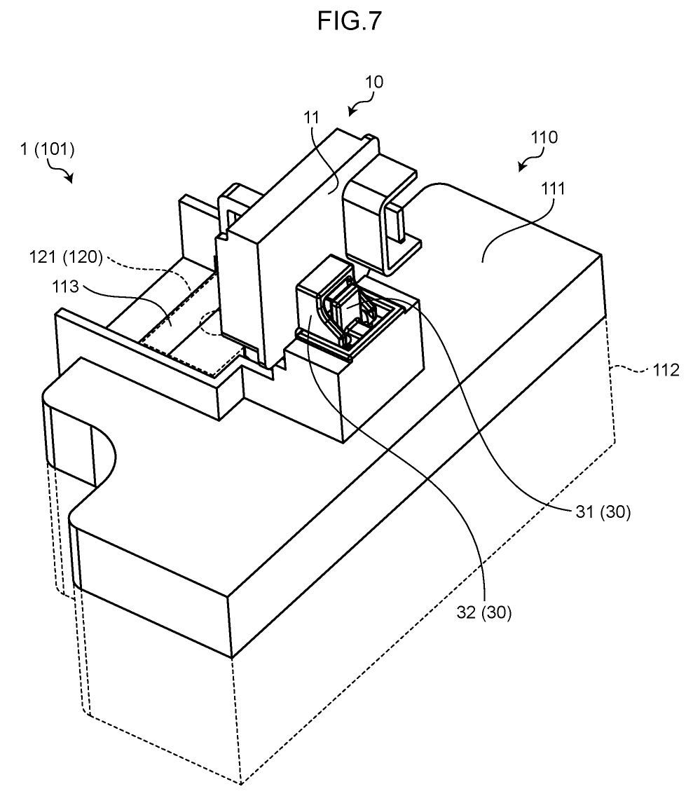

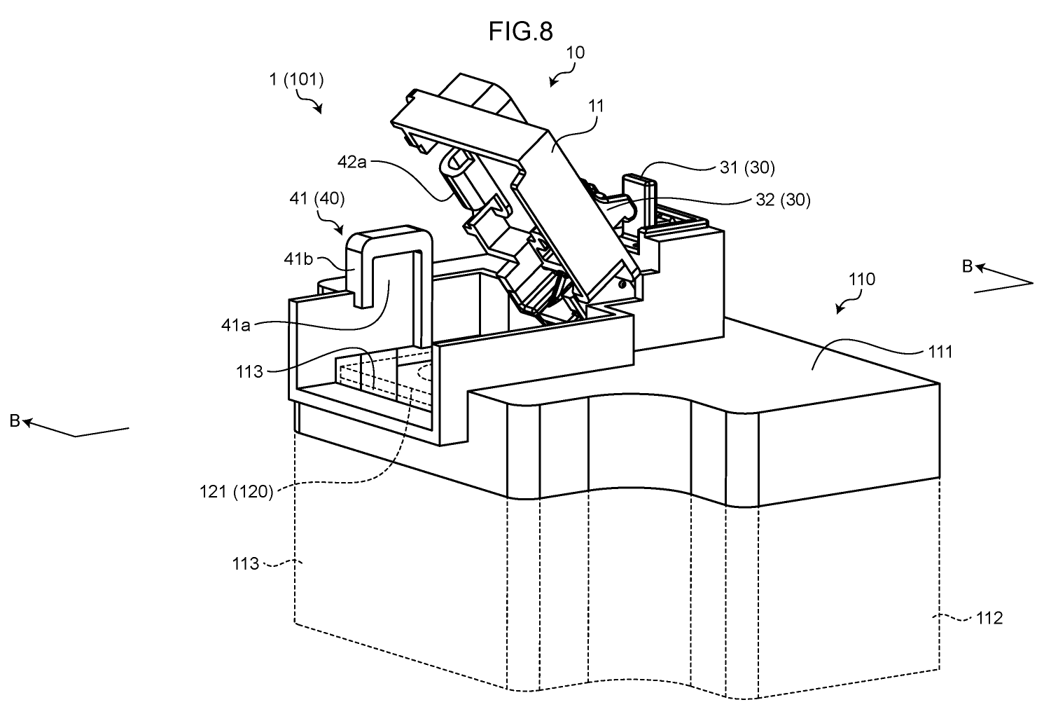

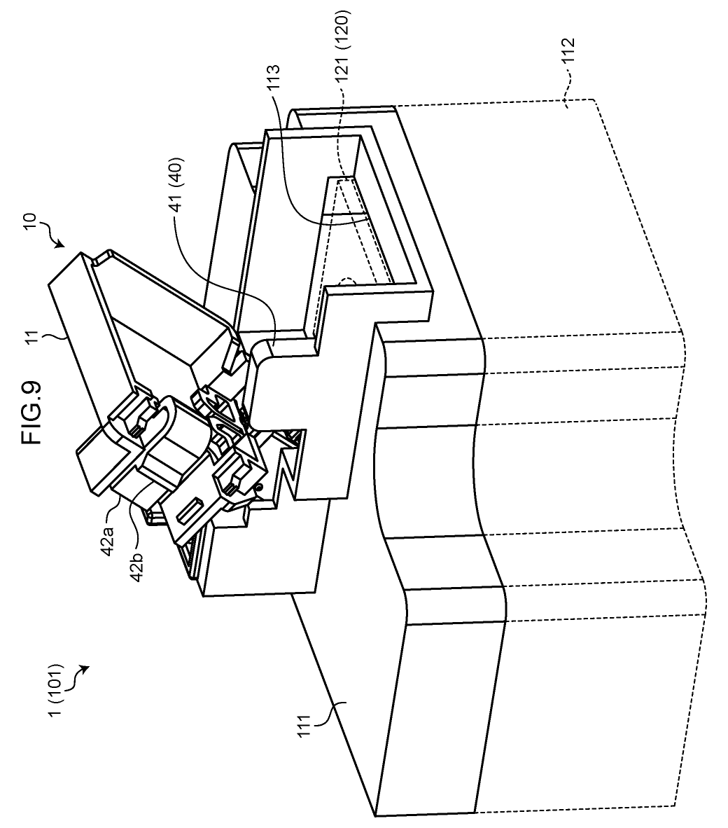

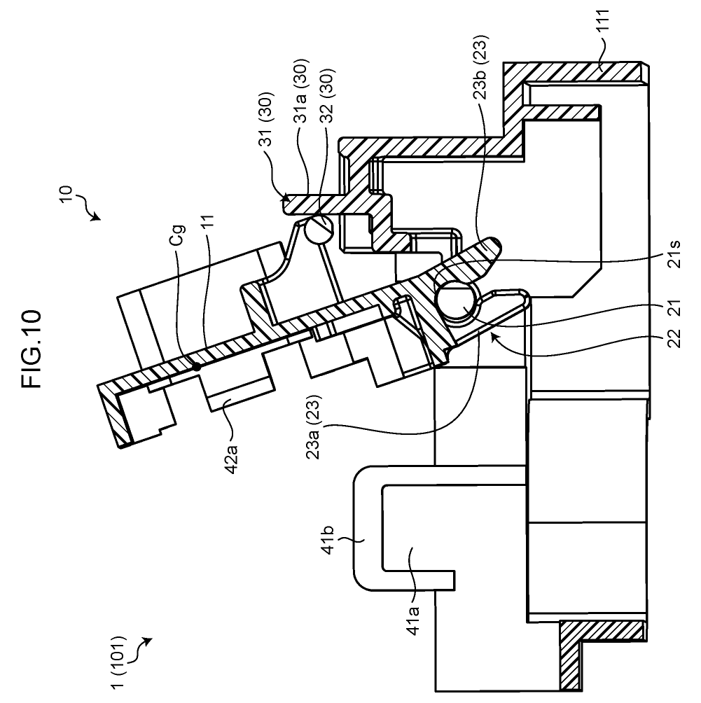

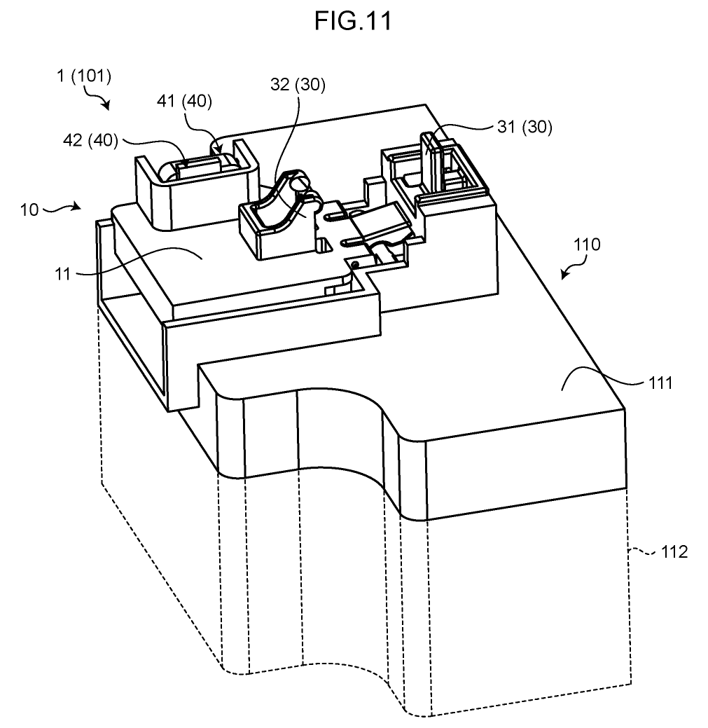

Embodiments are now described with reference to FIGS. 1 to 11. FIG. 1 is an exploded perspective view illustrating a protective cover assembly structure and an electrical junction box according to the embodiment, FIG. 2 is a perspective view illustrating the protective cover assembly structure and the electrical junction box according to the embodiment, FIG. 3 is a perspective view illustrating the protective cover according to the embodiment, FIG. 4 is a plan view illustrating a cover member according to the embodiment, FIG. 5 is a cross-sectional view taken along line A-A in FIG. 2, FIG. 6 is a plan view illustrating the protective cover assembly structure according to the embodiment, FIG. 7 is a perspective view of the protective cover assembly structure according to the embodiment from a different angle, FIG. 8 is a perspective view illustrating the protective cover assembly structure and the electrical junction box according to the embodiment, FIG. 9 is a perspective view illustrating the protective cover assembly structure and the electrical junction box according to the embodiment from a different angle, FIG. 10 is a cross-sectional view taken along line B-B in FIGS. 8, and 11 is a perspective view illustrating the protective cover assembly structure and the electrical junction box according to the embodiment. Moreover, FIGS. 6 and 7 illustrate the protective cover in an assembly position. In addition, FIGS. 8 and 9 illustrate the protective cover in an open position. Furthermore, FIG. 11 illustrates the protective cover in a closed position.

As illustrated in FIG. 1, an assembly structure 1 of a protective cover 10 according to an embodiment includes the protective cover 10, a pivot shaft 21, and a bearing 22. The protective cover 10 is a component configured to expose an opening 113 of an assembly target member 110 in an open position relative to the assembly target member 110 and to cover the opening 113 with a main body 11 of the protective cover in a closed position relative to the assembly target member 110.

In the embodiment, an electric junction box 101 is illustrated as an example of an application target of the assembly structure 1 of the protective cover 10. The electrical junction box 101 can be referred to as a so-called relay box or junction box. The electrical junction box 101 is connected between a power source such as a battery and various electric devices installed in a vehicle, for example, via an electric wire or the like. The electrical junction box 101 distributes the power supplied from the power source to the various electric devices in the vehicle.

The electrical junction box 101 is provided with a housing member serving as the assembly target member 110 to which the protective cover 10 is to be assembled. In the following description, the "assembly target member 110" can also be referred to as the "housing member 110". In the embodiment, the housing member 110 includes a cover member 111 and a main body portion 112. The main body portion 112 is a box-shaped structure with an opening at its upper side and is configured to house electronic components (such as a relay), electrical connection member 120, and the like.

The electrical connection member 120 is, for example, a metallic bus bar and is provided with an electrical connection terminal 121 that is physically and electrically connected to a mating conductive component. The cover member 111 is a component that covers the opening of the main body portion 112 from above. The cover member 111 is formed with an opening 113, and is attached to the main body portion 112 such that the electrical connection terminal 121 is exposed through the opening 113.

In the embodiment, the pivot shaft 21 is provided on the housing member 110 (specifically, the cover member 111), and the bearing 22 is provided on the protective cover 10. The bearing 22 includes a clamping portion 23 that clamps the pivot shaft 21, and is configured to allow the protective cover 10 to pivot about the axis of the pivot shaft 21 between an open position and a closed position. The protective cover 10 exposes the opening 113 of the cover member 111 in the open position relative to the cover member 111 and covers the opening 113 with the main body 11 of the protective cover in the closed position relative to the cover member 111.

Moreover, in the following description, the direction from the open position toward the closed position about the axis of the pivot shaft 21 is referred to as a closing direction, and the direction from the closed position toward the open position is referred to as an opening direction.

The assembly structure 1 of the protective cover 10 according to the embodiment includes a temporary holding mechanism 30 that temporarily retains the protective cover 10 at an assembly position that is further toward the opening direction from the open position. Specifically, the assembly position refers to the position where the protective cover 10 is assembled to the cover member 111 of the housing member 110 (the assembly target member 110), as described in detail later, and is located on the side opposite to the closed position with respect to the open position. The protective cover 10 exposes the opening 113 even at the assembly position.

In the embodiment, the assembly position corresponds to a position obtained by pivoting the protective cover 10 by 90 degrees toward the open position from the closed position. In addition, the open position is a position between the closed position and the assembly position, in which the protective cover 10 exposes the opening 113 after the temporary holding at the assembly position by the temporary holding mechanism 30 is released.

The temporary holding mechanism 30 temporarily retains the protective cover 10 at the assembly position by engaging a first locked member 32 of the protective cover 10 with a first locking member 31 of the cover member 111 in the assembly position. As illustrated in FIG. 1, the first locking member 31 includes a locking portion 31a on at least one of the opposite ends as viewed from the axial direction of the pivot shaft 21, which engages the first locked member 32 at the temporary holding position and retains it in that position (FIG. 5). In the embodiment, the first locking member 31 is formed as a plate-like portion protruding from the cover member 111 in a direction opposite to the main body portion 112 (i.e., in the upward direction).

More specifically, the first locking member 31 is formed in a rectangular plate shape, having a cantilever shape with the cover member 111 side as its fixed end, and the first locking member 31 is further shaped such that both lateral edges, as viewed in the axial direction of the pivot shaft 21, extend along the protruding direction from the cover member 111. In the embodiment, a part of a side edge of the first locking member 31 is used as the locking portion 31a. In the embodiment, the first locking member 31 includes the locking portion 31a at each of the opposite ends in the axial direction of the pivot shaft 21. The protective cover 10 is provided with the corresponding first locked member 32 for each locking portion 31a.

The first locked member 32 includes a flexible portion 32a, which is formed as a cantilever projecting from the main body 11 of the protective cover in the opening direction and is deformable in the axial direction of the pivot shaft 21; and a locked protrusion portion 32b, which extends from the free end of the flexible portion 32a in the axial direction of the pivot shaft 21 and is configured to engage with and be retained by the locking portion 31a at the temporary holding position (FIGS. 3 and 5).

The flexible portion 32a is disposed to face the locking portion 31a in the axial direction of the pivot shaft 21 at the assembly position. In addition, at the assembly position, the free end of the flexible portion 32a is positioned further on the opening side than the locking portion 31a. In other words, in the temporary holding mechanism 30, the locking portion 31a is clamped between the main body 11 of the protective cover at the assembly position and the locked protrusion portion 32b, thereby holding the protective cover 10 in the assembly position.

The protective cover 10 is configured to be assembled to the cover member 111 by inserting the pivot shaft 21 between the clamping portions 23 at the assembly position. As illustrated in FIGS. 1 and 2, the protective cover 10 is assembled to the cover member 111 in an assembly direction that is opposite to the projecting direction of the first locking member 31.

FIG. 4 is a plan view of the cover member 111 as viewed from the side of the main body portion 112. In FIG. 4, the protective cover 10 is omitted for the sake of description. As illustrated in FIG. 4, the pivot shaft 21 includes a recessed portion 21a formed in a concave shape relative to an outer circumferential surface 21s of the pivot shaft 21. The recessed portion 21a is formed at a position on the pivot shaft 21 that faces the clamping portion 23, with the protective cover 10 being in the assembly position.

The pivot shaft 21 of the embodiment is formed in a cylindrical shape extending along the axial direction, and the recessed portion 21a is formed as a cutout portion obtained by partially cutting away the cylindrical shape. In the embodiment, the recessed portion 21a has a bottom surface formed as a flat surface.

As illustrated in FIGS. 1 and 3, the clamping portion 23 of the embodiment includes two first clamping sections 23a arranged on one side of the pivot shaft 21 and one second clamping section 23b arranged on the other side of the pivot shaft 21 as viewed from the axial direction of the pivot shaft 21. The first clamping section 23a and the second clamping section 23b are arranged in an alternating manner along the axial direction. In other words, the second clamping section 23b is positioned between the two first clamping sections 23a in the axial direction.

Further, as illustrated in FIG. 4, the recessed portion 21a of the embodiment includes two first recessed sections 21aa and one second recessed section 21ab. The first recessed section 21aa is formed in a one-to-one relationship with the first clamping section 23a at a portion facing the corresponding first clamping section 23a, with the protective cover 10 being in the assembly position. The second recessed section 21ab is formed at a portion facing the second clamping section 23b, with the protective cover 10 being in the assembly position. In other words, in the embodiment, the second recessed section 21ab is located between the two first recessed sections 21aa in the axial direction of the pivot shaft 21.

In the pivot shaft 21, a width W1 in the direction in which the protective cover 10 is clamped by the clamping portion 23 at the assembly position is smaller than a width W2 in the direction orthogonal to both the clamping direction and the axial direction (FIG. 5). Each of the first recessed sections 21aa is formed with a width W3 (length in the axial direction) sufficient to accommodate a part of the corresponding first clamping section 23a internally, and each of the second recessed sections 21ab is formed with a width W4 (length in the axial direction) sufficient to accommodate a part of the second clamping section 23b internally (FIG. 4). In addition, the recessed portion 21a is formed to a depth sufficient to prevent the protective cover 10 from being easily disengaged when the protective cover 10 is clamped by the clamping portion 23 of the bearing 22.

As illustrated in FIG. 3, each of the first clamping sections 23a includes a first bearing part 23aa, a first protruding part 23ab, and a first distal end part 23ac. The first bearing part 23aa, the first protruding part 23ab, and the first distal end part 23ac are provided in this order from the side of the main body 11 of the protective cover and are formed in a plate-like shape as a whole. In addition, the second clamping section 23b includes a second bearing part 23ba, a second protruding part 23bb, and a second distal end part 23bc. The second bearing part 23ba, the second protruding part 23bb, and the second distal end part 23bc are provided in this order from the side of the main body 11 of the protective cover and are formed in a plate-like shape as a whole.

The first bearing part 23aa and the second bearing part 23ba cooperatively clamp the pivot shaft 21 and constitute a portion assembled to the pivot shaft 21 in a slidable manner. In the embodiment, the first bearing part 23aa is formed as an arcuate portion having a surface facing the pivot shaft 21, which is recessed in the direction opposite to the pivot shaft 21. Likewise, the second bearing part 23ba is formed as an arcuate portion having a surface facing the pivot shaft 21, which is recessed in the direction opposite to the pivot shaft 21. The protective cover 10 is configured to pivot about the axis of the pivot shaft 21 by sliding contact between the first and second bearing parts 23aa and 23ba and the outer circumferential surface 21s of the pivot shaft 21.

The first protruding part 23ab is formed as an arcuate portion that projects toward the side of the second clamping section 23b as viewed from the axial direction of the pivot shaft 21, and the second protruding part 23bb is formed as an arcuate portion that projects toward the side of the first clamping section 23a as viewed from the axial direction of the pivot shaft 21. As viewed from the axial direction of the pivot shaft 21, the gap between the first protruding part 23ab and the second protruding part 23bb is narrower than the diameter of the pivot shaft 21.

The first distal end part 23ac is inclined such that, as viewed from the axial direction of the pivot shaft 21, the surface on the side facing the second clamping section 23b becomes farther from the second clamping section 23b from the base end toward the tip. The second distal end part 23bc is similarly inclined such that, as viewed from the axial direction of the pivot shaft 21, the surface on the side facing the first clamping section 23a becomes farther from the first clamping section 23a from the base end toward the tip. In other words, as viewed from the axial direction of the pivot shaft 21, the distance between the first distal end part 23ac and the second distal end part 23bc becomes narrower toward the side closer to the main body 11 of the protective cover. As viewed from the axial direction of the pivot shaft 21, the distance between the first protruding part 23ab and the second protruding part 23bb is narrower than that at other portions between the first clamping section 23a and the second clamping section 23b.

The bearing 22 receives the pivot shaft 21 between the first distal end part 23ac and the second distal end part 23bc, the gap between the first protruding part 23ab and the second protruding part 23bb is spread apart by the pivot shaft 21, and the pivot shaft 21 rides over the first protruding part 23ab and the second protruding part 23bb to be clamped between the first bearing part 23aa and the second bearing part 23ba, thereby being assembled to the pivot shaft 21.

In the assembly structure 1 of the protective cover 10 according to the embodiment, the first recessed section 21aa and the second recessed section 21ab are formed on the pivot shaft 21, so that when the bearing 22 is assembled to the pivot shaft, the amount of displacement required for the first clamping section 23a and the second clamping section 23b to clamp the pivot shaft can be reduced. In other words, when the pivot shaft 21 passes between the first protruding part 23ab and the second protruding part 23bb, the first protruding part 23ab passes through the first recessed section 21aa, and the second protruding part 23bb passes through the second recessed section 21ab. The recess depths of the first recessed section 21aa and the second recessed section 21ab formed on the pivot shaft 21 allow for a reduction in the displacement amount of the bearing 22 necessary for the pivot shaft 21 to pass through the gap between the first protruding part 23ab and the second protruding part 23bb. Thus, the force required for an operator to move the pivot shaft 21 through the gap between the first protruding part 23ab and the second protruding part 23bb to the position between the first bearing part 23aa and the second bearing part 23ba can be reduced. As a result, the assembly structure 1 of the protective cover 10 according to the embodiment can improve the ease of assembly when the protective cover 10 is assembled to the assembly target member 110. In addition, the first recessed section 21aa and the second recessed section 21ab also function as guide portions that guide the first clamping section 23a and the second clamping section 23b to their predetermined positions as the pivot shaft 21 is inserted between the first clamping section 23a and the second clamping section 23b.

Further, in the protective cover 10 according to the embodiment, as illustrated in FIGS. 5 and 6, the locking portion 31a is clamped between the main body 11 of the protective cover and the locked protrusion portion 32b at the assembly position. Then, the protective cover 10 in the assembly position is in a state where the locking portion 31a is clamped between the main body 11 of the protective cover and the locked protrusion portion 32b for each first locked member 32. In other words, the protective cover 10 includes a space portion 12 surrounded by the main body 11 of the protective cover, a pair of flexible portions 32a, and a pair of locked protrusion portions 32b, and the first locking member 31 is inserted into the space portion 12 when the protective cover 10 is in the assembly position.

The protective cover 10 is assembled to the cover member 111 by the insertion of the pivot shaft 21 between the clamping portions 23 at the assembly position. The first locking member 31 is inserted from its free end into the space portion 12 in conjunction with the assembly operation of the protective cover 10 to the cover member 111. In other words, the pair of first locked members 32 are configured to insert the first locking member 31 into the space portion 12 from its free end in conjunction with the assembly operation of the protective cover 10 to the cover member 111. The insertion of the first locking member 31 into the space portion 12 causes the protective cover 10 to be temporarily held at the assembly position by the temporary holding mechanism 30 (FIG. 7).

For example, the electrical junction box 101 is manufactured at one location and then transported to another location where the counterpart conductive component is physically and electrically connected to the electrical connection terminal 121. In the electrical junction box 101 according to the embodiment, the protective cover 10 is temporarily held in the assembly position during transport from the manufacturing site to the location where the connection operation with the counterpart conductive component is performed. After completing the connection of the counterpart conductive component, an operator performing the work of connecting the counterpart conductive component displaces the protective cover 10 from the assembly position to the closed position.

In the temporary holding mechanism 30 according to the embodiment, the locked protrusion portion 32b includes an input portion 32c that, when the protective cover 10 in the assembly position is pivoted in the closing direction, is subjected to a force to a contact position with the locking portion 31a, receives a reaction force from the contact position with the locking portion 31a, and causes the flexible portion 32a to undergo elastic deformation to allow the locking portion 31a to be ridden over (FIG. 3).

The input portion 32c is a wall surface that is inclined with respect to the axial direction of the pivot shaft 21 and is disposed to face the locking portion 31a at the contact position with the locking portion 31a, and is formed as an inclined surface in which the protrusion amount from the free end of the flexible portion 32a gradually decreases in the closing direction. Thus, in the protective cover 10, when a force is applied in the closing direction at the assembly position, the input portion 32c of the locked protrusion portion 32b comes into contact with the locking portion 31a and applies a force to the locking portion 31a, and the input portion 32c receives a reaction force from the contact position with the locking portion 31a, causing the flexible portion 32a to elastically deform. In the protective cover 10 according to the embodiment, as the force in the closing direction continues to be applied, the amount of elastic deformation of the flexible portion 32a increases, allowing the locked protrusion portion 32b to ride over the locking portion 31a. This configuration makes it possible for the protective cover 10 to reach the open position and thereafter be displaced to the closed position.

In the locked protrusion portion 32b according to the embodiment, the input portion 32c is formed as a cylindrical member having an axis parallel to the axis of the pivot shaft 21, with an inclined surface formed on the free-end side of the cylinder.

Further, an operator is able to pivot the protective cover 10 from the closed position to the open position when performing maintenance or inspection of the electrical junction box 101. As illustrated in FIGS. 8 to 10, with the protective cover 10 in the open position, the locking portion 31a locks the movement of the locked protrusion portion 32b in the opening direction. This configuration allows the assembly structure 1 of the protective cover 10 according to the embodiment to prevent the protective cover 10 from returning to the assembly position after it has once been displaced from the assembly position to the open position.

The locking portion 31a and the locked protrusion portion 32b are formed in a shape that allows the locking portion 31a to continue to lock the locked protrusion portion 32b and retain the protective cover 10 in the open position when a force in the opening direction is applied to the protective cover 10 in the open position. Specifically, as illustrated in FIG. 10, the arcuate outer circumferential surface of the main portion of the locked protrusion portion 32b abuts against the locking portion 31a, allowing the locking portion 31a to continue to lock the locked protrusion portion 32b.

Further, with the protective cover 10 located within the range from the open position to the closed position, the clamping portion 23 of the bearing 22 clamps the outer circumferential surface 21s of the pivot shaft 21, rather than the bottom surface of the recessed portion 21a (FIG. 7). In other words, in the state where the protective cover 10 is located in the range from the open position to the closed position, the first bearing portion 22aa and the second bearing portion 22ba clamp the outer circumferential surface 21s of the pivot shaft 21. In the case of attempting to remove the protective cover 10 from the pivot shaft 21 while the protective cover 10 is located within the range from the open position to the closed position, the protruding portions of the bearing 22 (i.e., the first protruding part 23ab and the second protruding part 23bb) do not pass through the recessed section (i.e., the first recessed section 21aa and the second recessed section 21ab) of the pivot shaft 21, so it is necessary to spread apart the gap between the first protruding part 23ab and the second protruding part 23bb more significantly than when attempting to remove the protective cover 10 from the pivot shaft 21 at the assembly position. Thus, with the protective cover 10 located within the range from the open position to the closed position, the clamping portion 23 is in a state that makes the protective cover 10 more difficult to remove from the pivot shaft 21 than when the protective cover 10 is located at the assembly position. The temporary holding mechanism 30 according to the embodiment is capable of restricting the protective cover 10 from returning from the open position to the assembly position, which makes it possible for the protective cover 10 to be held in a state in which the protective cover 10 is less likely to be detached from the pivot shaft 21.

Further, as illustrated in FIGS. 8 and 9, the assembly structure 1 of the protective cover 10 and the electrical junction box 101 according to the present embodiment are provided with a holding mechanism 40 that holds the protective cover 10 in the closed position. The holding mechanism 40 includes a second locking member 41 provided on the cover member 111 of the housing member 110 (assembly target member 110) and a second locked member 42 provided on the protective cover 10, and these are locked to each other to hold the protective cover 10 in the closed position (FIG. 11).

The second locking member 41 includes a groove portion 41a, and a part of the peripheral wall of the groove portion 41a is used as a locking portion 41b. The second locked member 42 includes a flexible piece 42a formed in a flexible cantilever shape and a claw portion 42b protruding from one side surface of the flexible piece 42a.

Further, as illustrated in FIG. 10, the protective cover 10 is formed such that, in the open position, the protective cover 10 has a center of gravity Cg that is offset around the axis of the pivot shaft 21 in the open position from the vertically upper side of the pivot shaft 21 toward the closed position side. Thus, the protective cover 10, in the open position, returns to the closed position under its own weight if no external force is applied (FIG. 11).

Moreover, the above description uses an example of a configuration in which the pivot shaft 21 is provided on the assembly target member 110 and the bearing 22 is provided on the protective cover 10, but this exemplary configuration is not limited thereto. For example, a configuration in which the pivot shaft 21 can instead be provided on the protective cover 10 and the bearing 22 can be provided on the assembly target member 110 is possible.

As described above, the assembly structure 1 of the protective cover 10 according to the embodiment includes the protective cover 10, the pivot shaft 21, and the bearing 22, in which the protective cover 10 exposes the opening 113 of the main body portion of the assembly target member 110 when in an open position relative to the assembly target member 110 and covers the opening 113 with the main body 11 of the protective cover when in a closed position; the pivot shaft 21 is provided on one of the assembly target member 110 and the protective cover 10; the bearing 22 is provided on the other of the assembly target member 110 and the protective cover 10 and includes the clamping portion 23 that clamps the pivot shaft 21; the bearing 22 is configured to allow the protective cover 10 to pivot about an axis of the pivot shaft 21 between the open position and the closed position; the protective cover 10 is configured to be attachable to the assembly target member 110 by inserting the pivot shaft 21 between the clamping portions 23 at the assembly position located further in the opening direction than the open position; and the pivot shaft 21 includes the recessed portion 21a that is formed in a concave shape on the outer circumferential surface 21s at a position facing the clamping portion 23 when the protective cover 10 is in the assembly position.

In the assembly structure 1 of the protective cover 10 according to the embodiment, the pivot shaft 21 includes the recessed portion 21a formed in a portion that faces the clamping portion 23 when the protective cover 10 is in the assembly position. The assembly structure 1 of the protective cover 10 according to the embodiment allows the displacement of the clamping portion 23 during clamping of the pivot shaft 21 to be reduced. The assembly structure 1 of the protective cover 10 according to the embodiment is possible to facilitate the assembly of the bearing 22 to the pivot shaft 21, thereby improving the ease of assembly.

Further, in the assembly structure 1 of the protective cover 10 according to the embodiment, the clamping portion 23 includes two first clamping sections 23a arranged on one side of the pivot shaft 21 and one second clamping section 23b arranged on the other side of the pivot shaft 21 as viewed in the axial direction of the pivot shaft 21; the first clamping section 23a and the second clamping section 23b being arranged alternately along the axial direction, and the recessed portion 21a includes the first recessed section 21aa facing the first clamping sections 23a and the second recessed section 21ab facing the second clamping section 23b when the protective cover 10 is in an assembly position on the pivot shaft 21; and each of the first recessed section 21aa and the second recessed section 21ab is formed with a flat bottom surface.

In the assembly structure 1 of the protective cover 10 according to the embodiment, the recessed portions 21a (the first recessed section 21aa and the second recessed section 21ab) are formed in the portion facing the first clamping section 23a and the portion facing the second clamping section 23b, respectively, when the protective cover 10 is in the assembly position. The pivot shaft 21 is inserted into the first clamping section 23a and the second clamping section 23b in a manner that spreads the gap between the first clamping section 23a and the second clamping section 23b, but in the assembly structure 1 of the protective cover 10 according to the embodiment, during the assembly of the protective cover 10, the pivot shaft 21 is inserted between the first clamping section 23a and the second clamping section 23b, with the recessed portion 21a (the first recessed section 21aa and the second recessed section 21ab) aligned to face the clamping portion 23 (the first clamping section 23a and the second clamping section 23b). The bearing 22 is assembled to sandwich the portion of the pivot shaft 21 that is partially narrowed by the formation of the recessed portion 21a, so that the amount of displacement of the bearing 22 when the bearing 22 is assembled to the pivot shaft 21 can be reduced. The assembly structure 1 of the protective cover 10 according to the embodiment is possible to facilitate the assembly of the bearing 22 to the pivot shaft 21, thereby improving the ease of assembly.

Further, the assembly structure 1 of the protective cover 10 according to the embodiment further includes the temporary holding mechanism 30 configured to temporarily retain the protective cover 10 at the assembly position, in which the temporary holding mechanism 30 includes the first locking member 31 formed on the assembly target member 110 and the first locked member 32 formed on the protective cover 10. The first locking member 31 includes the locking portion 31a configured to temporarily hold the protective cover 10 at the assembly position by engaging the first locked member 32 at least on one of both ends in the axial direction of the pivot shaft 21. The first locked member 32 includes the flexible portion 32a in the form of a cantilever shape that protrudes from the main body 11 of the protective cover toward a side opposite to the closed position and is deformable in the axial direction and the locked protrusion portion 32b protruding in the axial direction from the free end of the flexible portion 32a and locked to the locking portion 31a. The locked protrusion portion 32b includes the input portion 32c that applies force to the contact position with the locking portion 31a when the protective cover 10 is pivoted from the assembly position toward the closed position, such that the flexible portion 32a is elastically deformed by a reaction force and causes the flexible portion 32a to ride over the locking portion 31a.

The assembly structure 1 of the protective cover 10 according to the embodiment includes the temporary holding mechanism 30 that temporarily retains the protective cover 10 in the assembly position. The temporary holding mechanism 30 includes the first locking member 31 formed on the assembly target member 110 and the first locked member 32 formed on the protective cover 10. This configuration makes it possible for, for example, a supplier who delivers a product incorporating the assembly structure 1 for the protective cover 10 to deliver the product in a state where the protective cover 10 is temporarily held in the assembly position (i.e., with the protective cover 10 open). Then, an operator is able to start work from the state where the protective cover 10 is temporarily held in the assembly position, thus allowing efficient operation.

Further, in the assembly structure 1 of the protective cover 10 according to the embodiment, in the state in which the protective cover 10 is in the assembly position, the flexible portion 32a is disposed to face the locking portion 31a in the axial direction, and the free end is arranged on the opposite side of the locking portion 31a from the closed position side in the assembly position, and the input portion 32c is a wall surface that is inclined in the axial direction and faces the locking portion 31a in the contact position, and is formed as an inclined surface that reduces the amount of protrusion from the free end of the flexible portion 32a toward the closed position side.

In the assembly structure 1 of the protective cover 10 according to the embodiment, the input portion 32c formed as an inclined surface makes it possible to reduce the force required to pivot the protective cover 10 from the assembly position to the closed position, improving the ease of assembly.

Further, in the assembly structure 1 of the protective cover 10 according to the embodiment, when a force directed toward the opposite side to the closed position is applied to the protective cover 10 in the open position, the locking portion 31a and the locked protrusion portion 32b come into contact with each other, thereby restricting the protective cover 10 from pivoting from the open position toward the assembly position.

In the assembly structure 1 of the protective cover 10 according to the embodiment, the locking portion 31a locks the locked protrusion portion 32b, thereby restricting the protective cover 10 from pivoting from the open position toward the assembly position. The assembly structure 1 of the protective cover 10 according to the embodiment is capable of preventing the protective cover 10 from being held in the assembly position (i.e., the state where the protective cover is open), thereby enhancing safety.

Furthermore, the electrical junction box 101 according to the embodiment includes the housing member 110, the protective cover 10, the pivot shaft 21, and the bearing 22, in which the housing member 110 houses an electrical connection member provided with an electrical connection terminal that physically and electrically connects a conductive component of a counterpart device and exposes the electrical connection terminal from the opening 113; the protective cover 10 exposes the opening 113 and the electrical connection terminal of the housing member 110 in an open position relative to the housing member 110 and covers the opening 113 and the electrical connection terminal with the main body 11 of the protective cover in a closed position relative to the housing member 110; the pivot shaft 21 is provided on one of the housing member 110 and the protective cover 10; and the bearing 22 is provided on the other of the housing member 110 and the protective covers 10 and having the clamping portion 23 that clamps the pivot shaft 21. The bearing 22 is configured to allow the protective cover 10 to pivot around the axis of the pivot shaft 21 between an open position and a closed position. The protective cover 10 is configured to be able to be assembled to the housing member 110 by inserting the pivot shaft 21 between the clamping portions 23 at an assembly position further in the opening direction than the open position, the pivot shaft 21 includes the recessed portion 21a formed in a concave shape with respect to the outer circumferential surface 21s of the pivot shaft 21 at a portion facing the clamping portion 23 when the protective cover 10 is in the assembly position.

In the electrical junction box 101 according to the embodiment, the pivot shaft 21 includes the recessed portion 21a formed in a portion facing the clamping portion 23 when the protective cover 10 is in the assembly position. The electrical junction box 101 according to the embodiment allows a reduction in the amount of displacement of the clamping portion 23 when the clamping portion 23 clamps the pivot shaft during assembly of the bearing 22 to the pivot shaft. The electrical junction box 101 according to the embodiment enables easier assembly of the bearing 22 to the pivot shaft 21 and thus improves the ease of assembly.

### Modification of Embodiment

Moreover, in the above-described embodiment, the description is given an example in which the temporary holding mechanism 30 includes the first locking member 31 formed on the assembly target member 110 and the first locked member 32 formed on the protective cover 10, but the exemplary configuration is not the only possible configuration. For example, the temporary holding mechanism 30 can include the first locking member 31 formed on the protective cover 10 and the first locked member 32 formed on the assembly target member 110. In this case, the temporary holding mechanism 30 is configured to temporarily hold the protective cover 10 at the assembly position by locking the first locked member 32 of the assembly target member to the first locking member 31 of the protective cover 10 at the assembly position. For example, the first locking member 31 protrudes from the protective cover 10 in the opening direction, and the first locked member 32 protrudes upward from the assembly target member 110 to clamp the first locking member 31 of the protective cover 10 in the assembly position. The first locked member 32 includes the flexible portion 32a having a cantilever shape that is deformable in the axial direction, and the locked protrusion portion 32b that protrudes in the axial direction from the free end of the flexible portion 32a and is locked by the locking portion 31a. In addition, when the protective cover 10 in the assembly position is pivoted toward the closed position, a force is applied to the contact position with the locking portion 31a, and the locked protrusion portion 32b receives a reaction force from the contact position, and causes the flexible portion 32a to elastically deform to allow the locked protrusion portion 32b to ride over the locking portion 31a.

The assembly structure 1 of the protective cover 10 according to the modification further includes the temporary holding mechanism 30 that temporarily retains the protective cover 10 in an assembly position, in which the temporary holding mechanism 30 includes the first locking member 31 formed on the protective cover 10 and the first locked member 32 formed on the assembly target member 110; the first locking member 31 includes the locking portion 31a for temporarily holding the protective cover 10 in an assembly position by locking the first locked member 32 to at least one of both ends in the axial direction of the pivot shaft 21; the first locked member 32 includes the flexible portion 32a in the form of a cantilever shape that protrudes from the assembly target member 110 in a direction opposite to the closed position and is deformable in the axial direction, and the locked protrusion portion 32b that protrudes axially from a free end of the flexible portion 32a and is locked by the locking portion 31a; the locked protrusion portion 32b includes an input portion 32c that, when the protective cover 10 in the assembly position is pivoted toward the closed position, receives a force at a contact position with the locking portion 31a, receives a reaction force from the contact position, and causes the flexible portion 32a to undergo flexural deformation to allow the locking portion 31a to be ridden over.

The assembly structure 1 of the protective cover 10 according to the modification includes the temporary holding mechanism 30 that temporarily retains the protective cover 10 in the assembly position. The temporary holding mechanism 30 includes the first locking member 31 formed on the protective cover 10 and the first locked member 32 formed on the assembly target member 110. This configuration even makes it possible for a supplier who delivers a product incorporating the assembly structure 1 for the protective cover 10 to deliver the product in a state where the protective cover 10 is temporarily held in the assembly position (i.e., with the protective cover 10 in an open state). Then, an operator is able to start work from the state where the protective cover 10 is temporarily held in the assembly position, thus allowing efficient operation.

The details disclosed in the above embodiments and modified examples can be implemented in combination as appropriate.

The protective cover assembly structure and the electrical junction box according to the present embodiment achieve the advantageous effect of improving the ease of assembly.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A protective cover assembly structure, comprising:
a protective cover configured to, in an open position with respect to an assembly target member, expose an opening of a main body portion of the assembly target member, and in a closed position with respect to the assembly target member, cover the opening with a main body of the protective cover;
a pivot shaft provided on one of the assembly target member and the protective cover; and
a bearing provided on the other of the assembly target member and the protective cover, the bearing having a clamping portion that clamps the pivot shaft, wherein
the bearing is configured to allow the protective cover to pivot about an axis of the pivot shaft between the open position and the closed position,
the protective cover is configured to be assembled to the assembly target member by inserting the pivot shaft between the clamping portions at an assembly position that is further on an opening side beyond the open position, and
the pivot shaft includes a recessed portion formed in a concave shape on an outer circumferential surface of the pivot shaft at a location facing the clamping portion in a state where the protective cover is in the assembly position.

2. The protective cover assembly structure according to claim 1, wherein
the clamping portion includes two first clamping sections arranged on one side of the pivot shaft in an axial direction of the pivot shaft, and one second clamping section arranged on the other side of the pivot shaft,
the first clamping section and the second clamping section are arranged alternately along the axial direction,
the recessed portion includes a first recessed section facing the first clamping sections and a second recessed section facing the second clamping section in the state where the protective cover is in the assembly position, and
each of the first recessed section and the second recessed section is formed with a flat bottom surface.

3. The protective cover assembly structure according to claim 1, further comprising:
a temporary holding mechanism that temporarily retains the protective cover in the assembly position, wherein
the temporary holding mechanism includes a first locking member formed on the assembly target member and a first locked member formed on the protective cover,
the first locking member includes a locking portion that is provided in at least one of both ends of the pivot shaft in the axial direction and that temporarily retains the protective cover in the assembly position by locking the first locked member,
the first locked member includes a flexible portion of a cantilever shape and a locked protrusion portion, the flexible portion protruding from the main body of the protective cover in a direction opposite to the closed position and deformable in the axial direction, and the locked protrusion portion protruding from a free end of the flexible portion in the axial direction and lockable to the locking portion,
the locked protrusion portion includes an input portion that applies a force against the locking portion at a contact position when the protective cover at the assembly position is pivoted toward the closed position and receives a reaction force from the contact position, causing the flexible portion to elastically deform and allow the locked protrusion portion to ride over the locking portion.

4. The protective cover assembly structure according to claim 1, further comprising:
a temporary holding mechanism that temporarily retains the protective cover in the assembly position, wherein
the temporary holding mechanism includes a first locking member formed on the protective cover and a first locked member formed on the assembly target member,
the first locking member includes a locking portion that is provided in at least one of both ends of the pivot shaft in the axial direction and that temporarily retains the protective cover at the assembly position by locking the first locked member,
the first locked member includes a flexible portion of a cantilever shape and a locked protrusion portion, the flexible portion protruding from the assembly target member in a direction opposite to the closed position and deformable in the axial direction, and the locked protrusion portion protruding from a free end of the flexible portion in the axial direction and lockable to the locking portion,
the locked protrusion portion includes an input portion that applies a force against the locking portion at a contact position when the protective cover at the assembly position is pivoted toward the closed position and receives a reaction force from the contact position, causing the flexible portion to elastically deform and allow the locked protrusion portion to ride over the locking portion.

5. The protective cover assembly structure according to claim 3, wherein,
in the state where the protective cover is at the assembly position, the flexible portion is disposed to face the locking portion in the axial direction, and the free end of the flexible portion is disposed on a side opposite to the closed position with respect to the locking portion in the assembly position, and
the input portion is a wall surface inclined with respect to the axial direction and disposed to face the locking portion at the contact position, the wall surface being formed as an inclined surface that decreases in an amount of protrusion from the free end of the flexible portion as the input portion extends toward the closed position.

6. The protective cover assembly structure according to claim 4, wherein,
in the state where the protective cover is at the assembly position, the flexible portion is disposed to face the locking portion in the axial direction, and the free end of the flexible portion is disposed on a side opposite to the closed position with respect to the locking portion in the assembly position, and
the input portion is a wall surface inclined with respect to the axial direction and disposed to face the locking portion at the contact position, the wall surface being formed as an inclined surface that decreases in an amount of protrusion from the free end of the flexible portion as the input portion extends toward the closed position.

7. The protective cover assembly structure according to claim 3, wherein,
in a case where a force is applied to the protective cover in the open position in a direction opposite to the closed position, the locking portion and the locked protrusion portion abut against each other to restrict pivoting of the protective cover from the open position toward the assembly position.

8. The protective cover assembly structure according to claim 4, wherein,
in a case where a force is applied to the protective cover in the open position in a direction opposite to the closed position, the locking portion and the locked protrusion portion abut against each other to restrict pivoting of the protective cover from the open position toward the assembly position.

9. An electrical junction box comprising:
a housing member that houses an electrical connection member having an electrical connection terminal configured to be physically and electrically connected to a conductive component of a counterpart device, the electrical connection terminal being exposed through an opening of the housing member;
a protective cover that, in an open position with respect to the housing member, exposes the opening of the housing member and the electrical connection terminal, and in a closed position with respect to the housing member, covers the opening and the electrical connection terminal with a main body of the protective cover;
a pivot shaft provided on one of the housing member and the protective cover; and
a bearing provided on the other of the housing member and the protective cover, the bearing having a clamping portion that clamps the pivot shaft, wherein
the bearing is configured to allow the protective cover to pivot about an axis of the pivot shaft between the open position and the closed position,
the protective cover is configured to be assembled to the housing member by inserting the pivot shaft between the clamping portions at an assembly position that is further on an opening side beyond the open position, and
the pivot shaft includes a recessed portion formed in a concave shape on an outer circumferential surface of the pivot shaft at a location facing the clamping portion in a state where the protective cover is in the assembly position.
